(19) United States
(12) Patent Application Publication
(10) Pub. No.: US 2024/0328318 A1
(43) Pub. Date: Oct. 3, 2024

(54) Thermal Blanket System and Method

(71) Applicant: Government of the United States, as represented by the Secretary of the Air Force, Wright-Patterson AFB, OH (US)

(72) Inventor: Thomas Koemel, Stillwater, OK (US)

(21) Appl. No.: 18/623,311

(22) Filed: Apr. 1, 2024

Related U.S. Application Data
(62) Division of application No. 17/522,295, filed on Nov. 9, 2021.

(51) Int. Cl. F01D 5/00; B32B 5/02; B32B 5/26; B32B 7/09

(52) U.S. Cl. CPC F01D 5/005; B32B 5/024; B32B 5/262; B32B 7/09; B32B 2250/03; B32B 2250/20; B32B 2255/02; B32B 2255/26; B32B 2260/021; B32B 2260/048; B32B 2262/0269; B32B 2262/101; B32B 2307/304; B32B 2307/518; B32B 2556/00; F05D 2230/80; F05D 2300/5024; F05D 2300/6012; F05D 2300/611

(57) ABSTRACT

Thermal insulation blankets and methods of using the same to repair articles, such as components of turbine engines are disclosed. The thermal insulation blankets are a multilayer composite material that includes: a first flexible fiberglass fabric layer having two sides that are coated with a coating that covers the fiberglass fibers; an intermediate second fiberglass insulation blanket layer made of continuous glass fibers; and a third layer of flexible heat reflective material. The method involves wrapping a component, such as a component of a turbine engine, with one or more thermal insulation blankets in order to retain heat within the confines of a prescribed area for installing or removing parts with a precision fitment. The blankets allow enough heat to induce even thermal expansion of the components.

### RIGHTS OF THE GOVERNMENT

The invention described herein may be manufactured and used by or for the Government of the United States for all governmental purposes without the payment of any royalty.

### FIELD OF THE INVENTION

The present invention relates generally to thermal insulation blankets, thermal insulation blanket systems and, more particularly, to thermal insulation blankets and methods of using the same to repair turbine engines, or other articles of manufacture.

### BACKGROUND OF THE INVENTION

Turbine engines, including jet engines, are composed of components that are manufactured with very tight tolerances. Such components comprise parts that fit together with very precise tolerances. Some of these components must be heated to elevated temperatures in order to install and/or remove parts from the component.

For example, there is a need for heating the inner portion of a Pratt and Whitney F100 229 jet engine inlet fan in order to install some of the parts therein. The engine manufacturer specifies using a heating element that is placed inside the inlet fan module, and wrapping the module in fiberglass blankets to retain the heat. The fiberglass blankets, however, have been found to not adequately retain heat, are difficult to handle, and provide a foreign object damage (FOD) risk to the jet engine, and a safety risk. More specifically, the OEM specified blankets would frequently leave fiberglass strands inside of the F100 inlet fan modules, and injure the hands of the mechanics who handle the blankets during operation.

Therefore, a need exists for improved thermal insulation blankets and methods of using the same to repair turbine engines.

### SUMMARY OF THE INVENTION

The present invention relates generally to thermal insulation blankets, thermal insulation blanket systems and, more particularly, to thermal insulation blankets and methods of using the same to repair turbine engines, or other articles of manufacture. While the invention will be described in connection with certain embodiments, it will be understood that the invention is not limited to these embodiments. To the contrary, this invention includes all alternatives, modifications, and equivalents as may be included within the spirit and scope of the present invention.

A thermal insulation blanket is provided that comprises a multilayer composite material having a first surface and a second surface. The multilayer composite material may comprise any suitable number of layers including two, three, or more. In one embodiment, the composite material may comprise:
a) a first layer comprising a flexible fiberglass fabric comprising fiberglass fibers having spaces between the fibers, the first layer having two sides that are coated and impregnated with a coating that substantially covers the fiberglass fibers;
b) an intermediate second layer comprising a fiberglass insulation blanket comprising continuous glass fibers; and
c) a third layer comprising a flexible heat reflective material having two surfaces, wherein one of the surfaces of said third layer comprises a heat reflective material,
wherein the first, second, and third layers are joined together with the second layer positioned between the first and third layers, and the heat reflective material of the third layer forms the second surface of the composite material.

A method of heating an article of manufacture that must undergo thermal expansion in order to repair or maintain the same is also provided. In one embodiment, the method is used for maintaining a gas turbine engine, or installing or removing parts from a component of a gas turbine engine, which component must be heated to an elevated temperature in order to install or remove the parts from the component.

The method may, in one embodiment, comprise the steps of:
a) optionally placing a component on a work surface;
b) at least partially wrapping the component with a multilayer composite material that will hold heated air adjacent to the component, the multilayer composite material comprising a coated fiberglass joined to an insulated flexible reflective layer;
c) placing a heating element adjacent the component;
d) covering the partially wrapped component and heating element with an insulating material;
e) heating the component to the desired temperature; and
f) removing the insulating material and the multilayer composite material from the component.

The method may further comprise a step g) of performing work on the component.

The steps of the method described above can be performed in any suitable manner, and in any suitable order.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a perspective view of one embodiment of an engine inlet fan module on a stand and the thermal insulation blanket system wrapped around the same.

FIG. 1A is a schematic side cross-sectional view taken along line 1A-1A of FIG. 1 showing the inlet fan module on the stand with a heating element on top of the fan module and the thermal insulation blanket system wrapped around both the inlet fan module and the heating element.

FIG. 2 is a plan view of one embodiment of a first component of the thermal insulation blanket system.

FIG. 3 is a side view of the first component, shown without the straps and buckles.

FIG. 4 is a plan view of one embodiment of a second component of the thermal insulation blanket system.

FIG. 5 is a side view of the second component, shown without the straps and buckles.

FIG. 6 is a plan view of one embodiment of a third component of the thermal insulation blanket system.

FIG. 7 is a side view of the third component.

FIG. 8 is a plan view of another embodiment of a second component of the thermal insulation blanket system.

FIG. 9 is a side view of the second component shown in FIG. 8, shown without the straps and buckles.

FIG. 10 is a plan view of another embodiment of a third component of the thermal insulation blanket system.

FIG. 11 is a side view of the third component shown in FIG. 10.

FIG. 12 is a plan view of another embodiment of a third component of the thermal insulation blanket system.

FIG. 13 is a side view of the third component shown in FIG. 12.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The present invention relates generally to thermal insulation blankets, thermal insulation blanket systems and, more particularly, to thermal insulation blankets and methods of using the same to repair turbine engines, or other articles of manufacture.

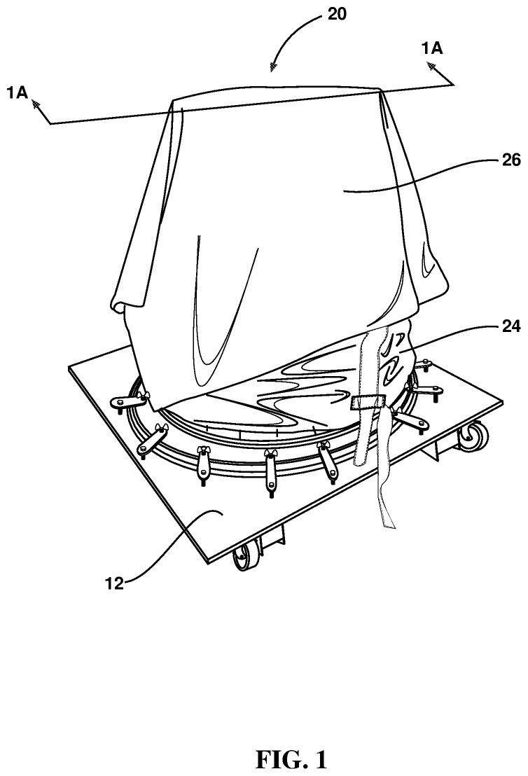

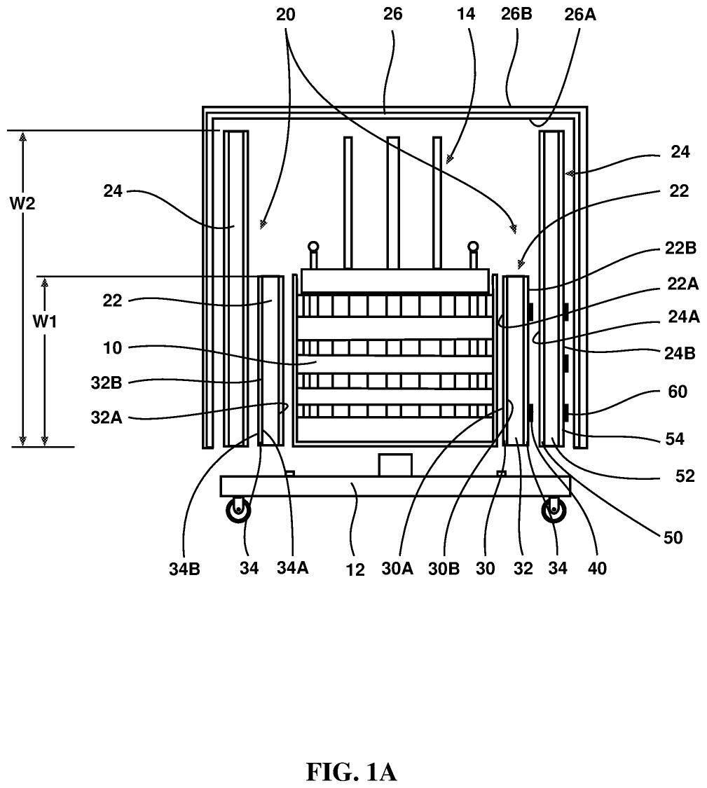

FIGS. 1 and TA show one non-limiting embodiment of the thermal insulation blanket system and a method of using the same to repair a turbine engine. The term “turbine engine”, as used herein, includes jet turbine, axial flow turbine, turbojet, turboprop, and turbofan engines. It should be understood, however, that the present invention can be used for wrapping or enclosing any type of article of manufacture that must undergo thermal expansion in order to repair or maintain the same, and is not limited to use in repairing turbine engines. The article of manufacture may be referred to herein as “the component” or “the workpiece”.

In the embodiment shown in FIGS. 1 and TA, the thermal insulation blankets are used to cover a semi-assembled inlet fan module 10 which rests on a fan build stand 12. In this case, the portion of the fan module 10 is the inner portion of an inlet fan. A heating element 14 is placed on top of the fan module 10. The inlet fan module 10, fan build stand 12, and heating element 14 will not be considered part of the system unless specifically included in the body of one or more of the appended claims (as opposed to the preamble).

The thermal insulation blanket system 20 embodiment shown in FIGS. 1 and TA comprises: a first thermal blanket 22, a second thermal blanket 24, and a third thermal blanket 26. This is only one possible embodiment of the thermal insulation blanket system. For instance, in another embodiment, the second thermal blanket can be eliminated and/or the first and second thermal blankets 22 and 24 can be combined into a unitary thermal blanket. If there is no second thermal blanket, the third thermal blanket will be referred to as an “additional thermal blanket”.

The first thermal blanket 22 comprises a multilayer composite material or structure having a first or inner surface 22A and a second or outer surface 22B. The multilayer composite material may comprise any suitable number of layers including two, three, or more. The first thermal blanket 22 and layers of the same should be flexible. The term “flexible”, as used herein means sufficiently flexible for wrapping around the component (e.g., of the turbine engine) that is being repaired. In one embodiment, the composite structure comprises: a) a first layer 30 having two sides 30A and 30B; b) an intermediate second layer 32 having two sides 32A and 32B; and c) a third layer 34 having two sides 34A and 34B. The first, second, and third layers are joined together with the second layer 32 positioned between the first 30 and third layers 34. The second side of the third layer 34 forms the second or outer surface 22B of the composite material or structure.

The first layer 30 of the composite material or structure can comprise any suitable flexible and safe-to-handle insulating material. In one non-limiting embodiment, the first layer 30 can comprise a flexible fiberglass fabric comprising fiberglass fibers having spaces (or interstices) between the fibers. The first layer has two sides 30A and 30B that are coated and impregnated with a coating that substantially (or preferably completely) covers the fiberglass fibers. One suitable material for the first layer is a 32 oz (1,085 g/m²) calendared woven flexible fiberglass fabric having sides that are coated and impregnated with silicone rubber. Such a material is known as the PYROBLANKET™ and is available from ADL Insulflex, Inc., Cobourg, Ontario, Canada. In the PYROBLANKET™, the coating is red silicone rubber, which is an elastomer containing silicon to which iron oxide has been added. This silicone rubber coated fabric is a soft, flexible, and easy to handle material that retains the sharp fiberglass strands. The silicone rubber also fills the spaces between the fiberglass strands, increasing the resistance of the material to convective heat.

The second layer 32 of the composite structure can comprise any suitable flexible insulating material, such as a fire retardant filler material. In one non-limiting embodiment, the second layer 32 can comprise fiberglass fibers since it is contained between the first and third layers 30 and 34. One suitable material is a needled fiberglass insulation blanket comprising 100% type E glass fibers having a density of 9-11 lbs/ft³ Insulmat blanket available from ADL Insulflex, Inc. Type E glass fibers are boron silicate glass fibers comprising less than 1% alkali oxide components such as aluminum oxide.

The third layer 34 of the composite structure can comprise any suitable flexible heat reflective layer that assists in retaining radiated heat. The third layer 34 comprises a flexible heat reflective material having two surfaces, wherein one of the surfaces of the third layer comprises a heat reflective material. In one non-limiting embodiment, the third layer 34 can comprise an aromatic polyamide (aramid) fiber substrate having two surfaces and a biaxially-oriented polyethylene terephthalate (BoPET) material applied to one surface 34B of the aramid substrate. One suitable material for the third layer 34 is a reflective engineered blanket such as the PYREFLECT™ blanket available from ADL Insulflex, Inc. In the PYREFLECT™ blanket, the aramid substrate is a 20 oz/yd² woven blend of poly-paraphenylene terephthalamide (KEVLAR®) fibers and aromatic polyamide (NOMEX®) fibers, and the biaxially-oriented polyethylene terephthalate material is a BoPET film (MYLAR®). The MYLAR® film provides the surface 34B with “aluminization”. This also provides a surface that has sufficient strength for attaching fasteners, such as straps, thereto.

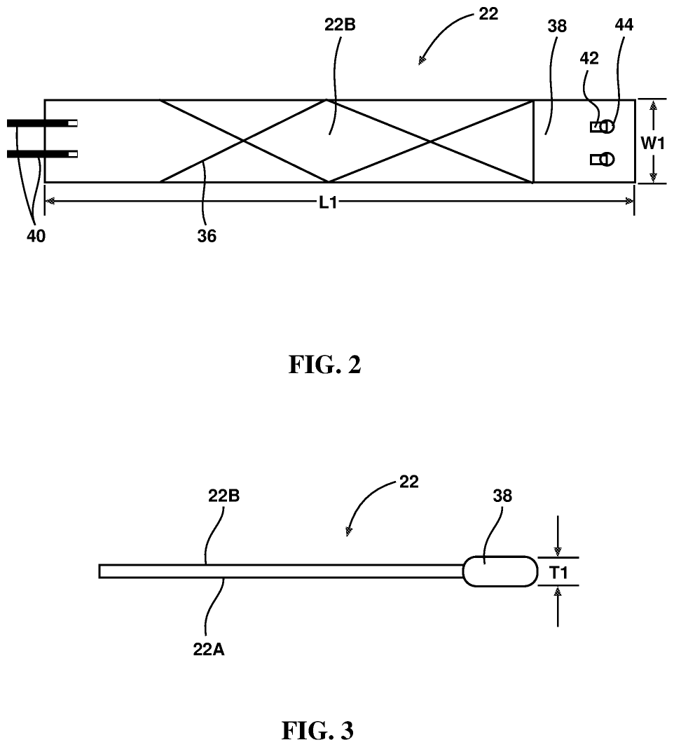

The layers of the first thermal blanket 22 may be joined together in any suitable manner. In some cases, the first and third layers 30 and 34 may be sized and configured to extend beyond the periphery of the second layer 32. FIG. 2 shows that the layers of the first thermal blanket 22 may be joined together by sewing or stitching 36 across the surface of the first thermal blanket, and around the perimeter of the first thermal blanket. The stitching 36 across the first thermal blanket can be in any suitable pattern, including a diagonal pattern as shown in the drawings.

FIGS. 2 and 3 show one configuration of the first thermal blanket 22. The first thermal blanket 22 has a length L1, a width W1, and a thickness T1. In the embodiment shown in FIG. 1A, the width W1 of the first thermal blanket 22 may correspond to the height of the first thermal blanket when it is wrapped around the workpiece. As shown in FIG. 2, the first thermal blanket 22 may have a generally rectangular plan view configuration. The first thermal blanket 22 may have any suitable dimensions. The dimensions will depend on ˜6˜the size and configuration of the component of the engine or other device that is being repaired. As shown in FIG. 3, the first thermal blanket 22 has a generally planar configuration. One end of the first thermal blanket may optionally comprise a thicker cushioned portion for preventing heat loss at the ends of the first thermal blanket when the first thermal blanket is wrapped around the workpiece and the ends of the first thermal blanket are secured in an overlapping configuration by fasteners.

The second surface 22B of the first thermal blanket 22 may have one or more straps 40 for securing the first thermal blanket 22 around the workpiece. The straps 40 are joined adjacent to one end of the first thermal blanket 22. The straps 40 have a fixed end that is joined to the second surface 22B of the first thermal blanket 22 (such as by sewing) and a free end for securing the straps. The straps 40 can be made from any suitable material. In some embodiments, the straps may comprise polyester, or similar fire retardant material. Several (e.g., shorter) lengths of the strap material can also be joined to the second surface 22B of the first thermal blanket 22 (such as by sewing) adjacent to the opposing end of the first thermal blanket 22. Stainless steel buckles 44 can be joined to the free ends of these lengths of strap material. The straps 40 can be connected via a loop between the buckles 44.

The second thermal blanket 24 may have any of the properties described above for the first thermal blanket 22. In the embodiment shown in FIGS. 1 and TA, the second thermal blanket 24 comprises a multilayer composite material or structure. These comprise a first layer 50, a second layer 52, and a third layer 54. These layers may comprise the same three layers as the first thermal blanket 22, or layers made of different types of materials. If the layers comprise the same three layers as the first thermal blanket 22, the first, second, and third layers 50, 52, and 54 of the second thermal blanket 24 will correspond to the first, second, and third layers 30, 32, and 34, respectively, of the first thermal blanket 22. The second thermal blanket 24 also has a first surface 24A and a second surface 24B.

In various embodiments, the first surface 24A of the second thermal blanket 24 may be oriented so that it faces toward the second surface 22B of the first thermal blanket 22. In other cases, the first surface 24A of the second thermal blanket 24 may be placed so that it faces away from the second surface 22B of the first thermal blanket 22. In FIG. 1A, the first surface 24A of the second thermal blanket 24 is positioned adjacent to the second surface 22B of the first thermal blanket 22. In the embodiment shown, the second thermal blanket 24 is wrapped around the first thermal blanket 22 so that any gaps formed in the wrapping of the first thermal blanket 22 that would allow heat to escape (such as where the straps 40 are secured to the buckles 44) are covered.

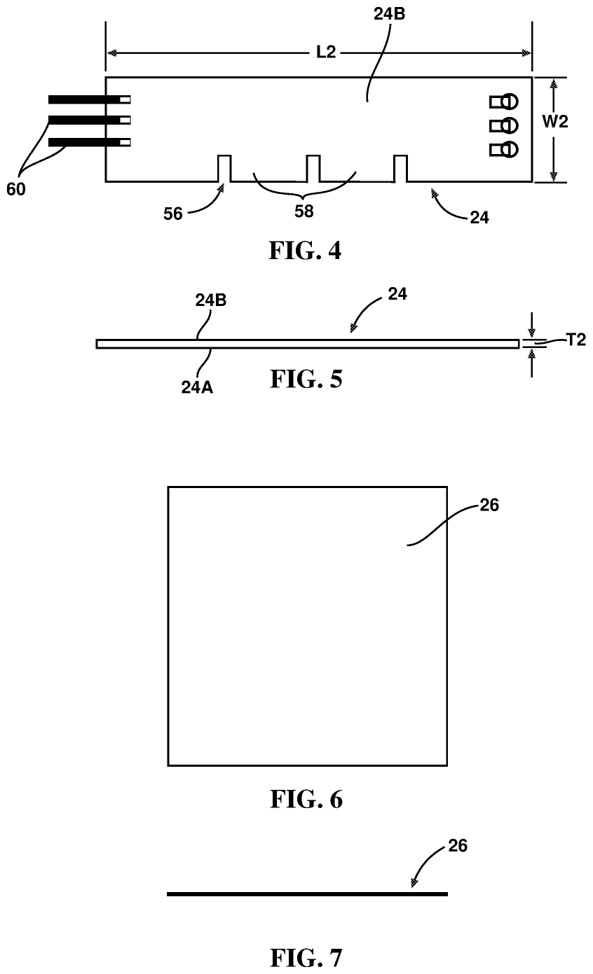

FIGS. 4 and 5 show one configuration of the second thermal blanket 24. The second thermal blanket 24 has a length L2, a width W2, and a thickness T2. In the embodiment shown in FIG. 1A, the width of the second thermal blanket 24 may correspond to the height of the second thermal blanket when it is wrapped around the workpiece. As shown in FIG. 1A, the width W2 of the second thermal blanket 24 may be greater than that of the first thermal blanket 22, so it has a greater height than the first thermal blanket 22 when the second thermal blanket 24 is wrapped around the workpiece. As shown in FIG. 4, the second thermal blanket 24 may have a generally rectangular plan view configuration with a plurality of notches 54 along one of the longer sides of the same to form a plurality of flaps 58 therebetween for folding over (e.g., the top of) the workpiece 10. The portion of the second thermal blanket 24 other than the flaps 58 may be referred to as a body portion. The second thermal blanket 24 may have any suitable dimensions. The dimensions will depend on the size and configuration of the component of the engine or other device that is being repaired. As shown in FIG. 5, when viewed from the side, the second thermal blanket 24 has a generally planar configuration.

The second surface 24B of the second thermal blanket 24 may have one or more straps 60 for securing the second thermal blanket 24 around the workpiece 10. The straps 60 can have any of the features described above for the straps that are joined to the first thermal blanket 22.

FIGS. 1 and 1A show the third thermal blanket 26 is placed (e.g. draped) over the top of the workpiece 10 and over the sides of the workpiece that are wrapped by the first and second thermal blankets 22 and 24. The third thermal blanket 26 has an inner first surface 26A and an outer second surface 26B.

The third thermal blanket 26 can comprise any suitable flexible insulating, and safe-to-handle material. The third thermal blanket 26 can comprise one or more of the materials specified as being suitable for the layers of the first thermal blanket 22. In one non-limiting embodiment, the third thermal blanket 26 can comprise a 32 oz (1,085 g/m²) woven flexible fiberglass fabric having two sides that are coated and impregnated with silicone rubber such as the PYROBLANKET™ available from ADL Insulflex, Inc. In another embodiment, the third thermal blanket 26 can comprise a two layer structure further comprising a flexible reflective layer joined to the coated fiberglass material that assists in retaining radiated heat such as that described above for the third layer 34 of the first thermal blanket 22. In the latter embodiment, the reflective layer may form the outer second surface 26B of the two layer structure.

FIGS. 6 and 7 show one configuration of the third thermal blanket 26. As shown in FIG. 6, the third thermal blanket 26 may have a generally rectangular (e.g., square) plan view configuration. The third thermal blanket 26 may have any suitable dimensions which will depend on the size and configuration of the component of the engine or other device that is being repaired. As shown in FIG. 7, the third thermal blanket 26 has a generally planar configuration.

The schematic view of FIG. TA shows spaces between the inlet fan module 10 and the thermal blankets 22, 24, and 26. Spaces are also shown between the first thermal blanket 22 and the second thermal blanket 22. It should be understood that this is merely a schematic depiction, and that it is desirable that each blanket will be installed in contact with, and will conform to and lie flush against the adjacent surface, whether it be the workpiece 10, or the adjacent blanket.

There are numerous, non-limiting embodiments of the invention. All embodiments, even if they are only described as being “embodiments” of the invention, are intended to be non-limiting (that is, there may be other embodiments in addition to these), unless they are expressly described as limiting the scope of the invention. Any of the embodiments described herein can also be combined with any other embodiments in any manner to form still other embodiments.

In other embodiments, one of the layers of the first thermal blanket 22, such as the second layer, may be optional. In such cases, if desired, features of one of the optional layers could be incorporated into the other layer(s).

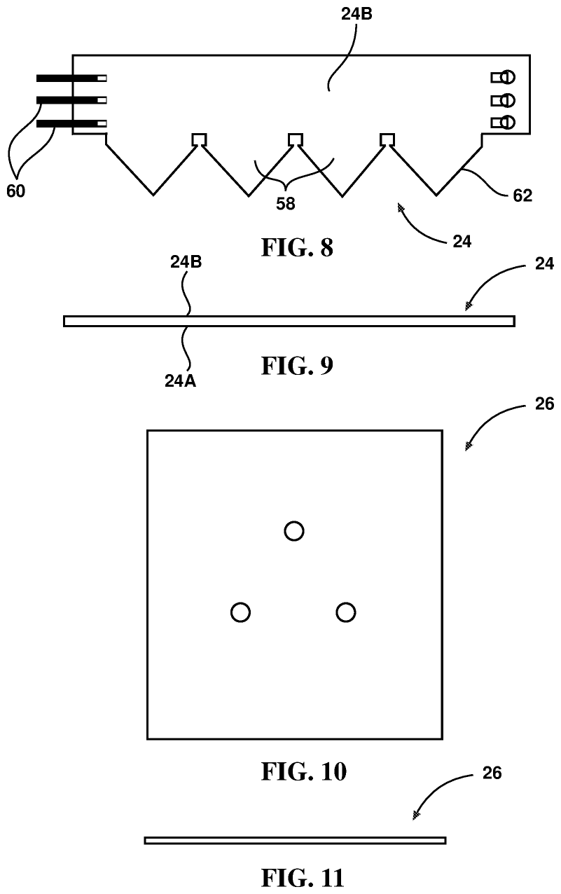

FIGS. 8 and 9 show an alternative configuration of the second thermal blanket 24. FIG. 8 shows that in this embodiment, the second thermal blanket 24 has a portion with a generally rectangular plan view configuration and portions along one of the longer sides of the same that form a plurality of triangular-shaped flaps 58. The edges of the triangular-shaped flaps 58 may have additional fasteners 62 joined thereto to fasten the flaps 58 together. Such additional fasteners 62 may include, but are not limited to zippers, buttons, or clasps.

In other embodiments, the second thermal blanket 24 may be optional. For instance, in other cases, an alternative fastening system can be used to fasten the first thermal blanket 22 around the workpiece that has less tendency to form gaps in the coverage of the wrapped first thermal blanket 22. For example, a zipper or other type of fastening system, can be used to fasten (e.g., the ends of) the first thermal blanket 22 to itself. In such cases, it may be possible to omit the second thermal blanket 24 for lower temperature installations and just make the first thermal blanket 22 a bit thicker. In cases in which the second thermal blanket 24 is not used, the first thermal blanket 22 may be provided with any of the features described herein for the second thermal blanket 24 including, but not limited to the flaps for folding over the workpiece and the fasteners thereon.

FIGS. 10 and 11 show an alternative embodiment of the third thermal blanket 26. In this embodiment, plurality of holes are formed in the third thermal blanket 26 to accommodate posts that may be joined to the heater 14. In the case of the heater used for the Pratt and Whitney F100 engine, the posts are provided so that the heater 14 is adjustable in height and can be set in different positions relative to the work surface.

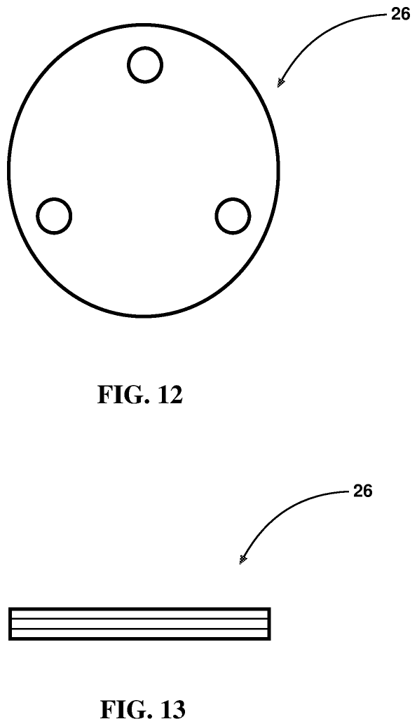

FIGS. 12 and 13 show another alternative embodiment of the third thermal blanket 26. In this embodiment, the third thermal blanket 26 may comprise a three layer structure. The three layer structure may comprise any suitable structure including, but not limited to the layer arrangements described above for the first and second thermal blankets 22 and 24. As shown in FIG. 12, the third thermal blanket 26 may have a circular plan view configuration for covering a cylindrical component.

A method of heating an article of manufacture that must undergo thermal expansion in order to repair or maintain the same is also provided. In one embodiment, the method is used for maintaining a gas turbine engine, or installing or removing parts from a component of a gas turbine engine, which component must be heated to an elevated temperature in order to install or remove the parts from the component is also provided.

The method may comprise the steps of.
a) optionally placing a component on a work surface;
b) at least partially wrapping the component with a multilayer composite material to hold heated air adjacent to the component, the multilayer composite material comprising a silicone rubberized coated fiberglass layer joined to an insulated flexible heat reflective layer (e.g., a first thermal blanket);
c) placing a heating element adjacent the component;
d) optionally covering the at least partially wrapped component and heating element with an insulating material (e.g., with a portion of the second thermal blanket, such as flaps; or with a third or an additional thermal blanket);
e) heating the component to the desired temperature;
f) removing any optional insulating covering material and the multilayer composite material from the component; and
g) optionally performing work on the component.

The phrase “at least partially wrapping”, as used herein, includes both partially wrapping the component, and completely wrapping the component with the composite material.

The steps of the method described above can be performed in any suitable manner and in any suitable order. In some cases, one or more steps are optional and can be eliminated. Several non-limiting examples various manners and orders of performing the method are as follows. These variations can also be combined in any suitable manner.

In one embodiment the component is the inner portion of a turbine engine inlet fan.

In one embodiment, in step (b) the multilayer composite material may further comprise an intermediate insulating layer positioned between the coated fiberglass layer and the insulated flexible heat reflective layer.

In another example, step (c) of placing the heating element adjacent to the component may comprise placing the heating element at least partially inside the component. In another example, step (c) can be performed prior to step (b) so that the heating element is placed adjacent to the component prior to step (b) of at least partially wrapping the component.

In another embodiment, the method may further comprise a step of providing a second thermal blanket with flaps thereon. This embodiment may comprise wrapping the second thermal blanket around the component (that is wrapped with the first thermal blanket), and folding the flaps over the component.

In step (e), the heating of the component can comprise heating the component to a temperature of from about 200° F. to about 500° F., or more. The surface temperature of the component (e.g., of metal surfaces) can be measured using infrared thermometers while the component is encapsulated by the blankets.

The thermal blanket system 20 utilizes materials that are typically used for fighting fires, or in an industrial setting for preventing high heat from damaging or burning objects. The thermal blanket system 20 described herein instead of suppressing heat, utilizes the materials to effectively wrap an object and build a form fitted oven around the object.

The thermal insulation blankets and methods of using the same to repair turbine engines described herein can provide a number of advantages. It should be understood, however, that these advantages need not be required unless they are set forth in the appended claims. The thermal insulation blanket system allows the workpiece to be heated faster and more effectively. The thermal insulation blankets provide an increased window of time for performing maintenance after heating the module. The thermal insulation blankets are durable, and reusable. There is no risk of foreign object damage to the engine from fiberglass shedding as when using the prior fiberglass thermal insulation blankets. The thermal insulation blankets are safer for handling by mechanics.

The term “joined”, as used herein, encompasses configurations in which an element is directly secured to another element by affixing the element directly to the other element; configurations in which the element is indirectly secured to the other element by affixing the element to intermediate member(s) which in turn are affixed to the other element; and configurations in which one element is integral with another element, i.e., one element is essentially part of the other element. The term “joined” includes both those configurations in which an element is temporarily joined to another element, or in which an element is permanently joined to another element.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1-11. (canceled)

12. A method of heating a component, which component must be heated to an elevated temperature in order to repair, or install or remove the parts from the component, said method comprising the steps of:
1) at least partially wrapping the component with a multilayer composite material that will hold heated air adjacent to the component, said multilayer composite material comprising a coated fiberglass material joined to an insulated flexible reflective layer;
2) placing a heating element adjacent said component;
3) covering the partially wrapped component and heating element with an insulating material;
4) heating the component to the desired temperature; and
5) removing the insulating material and the multilayer composite material from the component.

13. The method of claim 12 wherein the component is component of a gas turbine engine.

14-15. (canceled)

16. The method of claim 13 wherein the component is removed from the gas turbine engine prior to step 1).

17. The method of claim 16 wherein the component is the inner portion of a turbine engine inlet fan.

18. The method of claim 13 wherein the component is comprised of metal, and the step 4) of heating the component to the desired temperature induces thermal expansion of at least portions of the component.

19. The method of claim 18 further comprising a step 6) of performing work on the component which comprises maintaining, installing, or removing parts from the component of a gas turbine engine.

20. The method of claim 12 wherein said multilayer composite material comprises a first thermal blanket, and said method further comprises a step of wrapping said component and said first thermal blanket with a second thermal blanket after step 1) and before step 3).

21. The method of claim 20 wherein said second thermal blanket comprises a body portion and at least one side edge with a plurality of flaps along said side edge for folding over said component, and step 1) comprises wrapping the body portion of said second thermal blanket around said component; and step 3) comprises folding the flaps over the component.

22. The method of claim 12 wherein said multilayer composite material comprises a flexible multilayer composite material having a first surface and a second surface, said composite material comprising:
a) a first layer comprising said coated fiberglass material, said coated fiberglass material comprising fiberglass fibers having spaces between said fibers, said first layer having two sides that are coated and impregnated with a coating that covers said fiberglass fibers;
b) an intermediate second layer comprising a fiberglass insulation blanket comprising continuous fiberglass fibers; and
c) a third layer comprising said insulated flexible reflective layer, said insulated flexible reflective layer comprising a flexible material having two surfaces, wherein one of the surfaces of said third layer comprises a heat reflective material,
wherein said first, second, and third layers are joined together with said second layer positioned between said first and third layers, and said heat reflective material of said third layer forms the second surface of said composite material.
